(19) United States
(12) Patent Application Publication
(10) Pub. No.: US 2015/0074515 A1
(43) Pub. Date: Mar. 12, 2015

(54) SYSTEMS AND METHODS OF INFERENTIAL DEMOGRAPHIC ANALYTICS ON POTENTIAL SURVEY RESPONDENTS WHEN USING ONLINE INTERCEPT POLLS

(71) Applicant: RIWI Corp., Toronto (CA)

(72) Inventors: Neil Laurence Seeman, Toronto (CA); Alton Ing, North Vancouver (CA)

(21) Appl. No.: 14/483,639

(22) Filed: Sep. 11, 2014

Related U.S. Application Data
(60) Provisional application No. 61/876,282, filed on Sep. 11, 2013.

(51) Int. Cl. G06F 17/30

(52) U.S. Cl. CPC G06F 17/30887; G06F 17/30893; G06F 17/30905
USPC 715/234

(57) ABSTRACT

Various embodiments are described herein for methods and systems for carrying out inferential demographic analytics on potential survey respondents when using online intercept polls. In one example embodiment, the inferential demographic analytics system comprises a memory unit and a processing unit coupled to the memory unit. The processing unit is configured to direct respondents to one or more polling websites offering surveys using random URL intercepts, where the one or more respondents are connected to a network via a client system, record survey data corresponding to inputs provided by the one or more respondents to the surveys, determine demographics data for the one or more polling websites, where the demographics data comprise one or more attributes defining characteristics of the respondents, process the survey data based on the demographics data to generate processed survey data and store the survey data, the demographics data and the processed survey data in the memory unit.

### TECHNICAL FIELD

The described embodiments relate to methods and systems for providing inferential demographic analytics on survey respondents, and in particular, to methods and systems for providing inferential demographic analytics on survey respondents of online intercept polls.

### BACKGROUND

Surveys and public opinion polls, whether conducted by print medium or by telephone, and especially if conducted online, are tainted with coverage bias of those targeted for polling. This is because not all potential respondents in the entire population have an equal probability of being surveyed. Since the end goal of any surveyor or researcher is to obtain a representative random sample of the population of interest to participate in a given survey, there is a need for improved systems and methods of facilitating online surveys and polls to minimize, and even eliminate, coverage bias.

### SUMMARY

In a broad aspect, at least one embodiment described herein provides a method of operating an inferential demographic analytics system, the method comprises obtaining at least one processor to: direct respondents to one or more polling websites offering surveys using random URL intercepts, the one or more respondents being connected to a network via a client system; record survey data corresponding to inputs provided by the one or more respondents to the surveys; determine demographics data for the one or more polling websites, the demographics data comprising one or more attributes defining characteristics of the respondents; and process the survey data based on the demographics data to generate processed survey data; and storing the survey data, the demographics data and the processed survey data in a memory coupled to the at least one processor.

In some embodiments, the one or more attributes comprised in the demographics data are selected from the group consisting of age, gender, education level, ethnicity, income, Web browsing location, whether or not the respondents have children, browsing habits, political affiliation and voter preference.

In some embodiments, the demographics data are determined by downloading a browser-based software plug-in tool to the client system. In some other embodiments, the demographics data are determined via Web analytics using IP (Internet Protocol) cookies for gathering IP-specific information for the respondents.

In some embodiments, the IP-specific information is selected from the group consisting of geographic location, the relative number and proportion of unique visitors per day and per month registered from different country-specific IP addresses, the relative number and proportion of unique visitors per day and per month registered from different country-specific operating systems, and the relative number and proportion of unique visitors per day and per month registered from different country-specific browsers.

In some other embodiments, the demographics data are determined by applying domain demographics database on the polling websites deploying the surveys.

In some embodiments, the domain demographics database comprises a website. Examples of such websites may include Alexa™.com, Quantcast™ etc.

In some embodiments, the demographics data for a polling website are classified as statistically identical to the demographics data for a non-trademarked domain name, wherein the polling website and the domain name are identical in spelling with an exception of a single-letter typographical error and wherein the grammar and syntax in the proper spelling formulation of the domain name demonstrably signifies the intended content of the website corresponding to the domain name.

In some embodiments, the method of operating an inferential demographic analytics system further comprises sorting the demographics data based on pre-determined criteria.

In some embodiments, sorting the demographics data based on pre-determined criteria comprises sorting the demographics data based on location by using IP address of each client system corresponding to each respondent. In some other embodiments, sorting the demographics data based on pre-determined criteria comprises sorting the demographics data based on the one or more attributes. In some further embodiments, sorting the demographics data based on pre-determined criteria comprises sorting the demographics data based on the polling websites.

In some embodiments, the method of operating an inferential demographic analytics system further comprises extrapolating information from the survey data based on the demographics data.

In some embodiments, the extrapolated information comprises predictions regarding respondent opinions on certain issues.

In some embodiments, the method of operating an inferential demographic analytics system further comprises generating indicia of Web representativeness of respondents based on the demographics data.

In some embodiments, the Web representativeness is based on geography.

In some embodiments, the method of operating an inferential demographic analytics system further comprises re-weighting survey data based on the indicia of Web representativeness to generate processed survey data.

In some embodiments, the method of operating an inferential demographic analytics system further comprises providing online advertisements to the respondents based on a dominant attribute in the demographics data of the polling website.

In another embodiment, the method of operating an inferential demographic analytics system comprises providing online advertisements of increased relevance to the survey respondents, with higher advertising site relevance being determined by a dominant domain attribute of the survey domain(s), such as age, voter preference, gender or income.

In some embodiments, the method of operating an inferential demographic analytics system further comprises using Bayesian modeling or other statistical techniques to further assess the aggregate characteristics of the universe of people who answer different surveys over time, through the process of analyzing how the survey respondents to multiple surveys hosted on the same websites answer different questions, and, in this process, match the audience website profile characteristics to the answers to survey questions.

In some embodiments, the method of operating an inferential demographic analytics system further comprises redirecting respondents of completed surveys to online panel websites that offer recruited opt-in services, where the audience profile of the survey website or websites are similar to the audience profile of the online panel company, for instance, where the online panel company specializes in recruiting panelists from a specific age group, geography, gender or other characteristic inferred from the survey website(s).

In some embodiments, the method of operating an inferential demographic analytics system further comprises confirming population segmentation by city geo-location for survey domain audience profiling, using the Haversine formula and the Equirectangular approximation.

In another aspect, in at least one embodiment described herein, there is provided an inferential demographic analytics system comprising: a memory unit; and a processing unit coupled to the memory unit, the processing unit being configured to: direct respondents to one or more polling websites offering surveys using random URL intercepts, the one or more respondents being connected to a network via a client system; record survey data corresponding to inputs provided by the one or more respondents to the surveys; determine demographics data for the one or more polling websites, the demographics data comprising one or more attributes defining characteristics of the respondents; process the survey data based on the demographics data to generate processed survey data; and store the survey data, the demographics data and the processed survey data in the memory unit.

In another embodiment, the processing unit is configured to perform the methods as defined above or other methods in accordance with the teachings herein.

In some embodiments, the inferential demographic analytics system may offer the possibility of examining the Web representativeness, by geography, of the survey respondents as compared to the total audience profile of all survey domains, thereby enabling the re-weighting of online survey data to improve the representativeness of the final results in the context of the Web-based population parameter of interest to the researcher.

In some other embodiments, the inferential demographic analytics system may offer the possibility of providing online advertisements of greater relevance to those who have first been exposed to the domain intercept survey.

In some further embodiments, the inferential demographic analytics system may offer the capacity to redirect respondents of completed surveys to online panel websites that offer recruited opt-in services, where the audience profile of the survey website or websites is similar to the audience profile of the online panel company, for instance, where the online panel company specializes in recruiting panelists from a specific age group, geography, gender or other dominant user attribute inferred from the survey website(s).

In some embodiments, the inferential demographic analytics system may offer the ability to use Bayesian modeling [1] or related statistical techniques to further assess the characteristics of the universe of successive groups of people who answer different online intercept surveys over time, through the process of analyzing how the survey respondents to multiple surveys hosted on the same websites answer different questions, and, in the course of this process, supplement the audience website profile characteristics via the answers to the successive survey questions and responses.

In some other embodiments, the inferential demographic analytics system may enable predictive analytics to assess what people who inadvertently land on an unintended website (such as, top-level domains (TLDs), country-code top-level domains (ccTLDs), generic top-level domains (gTLDs), and international domain names (IDNs), etc.) may think about certain issues, by the method of extrapolating from the survey responses collected historically or contemporaneously from the survey websites.

In some further embodiments, the inferential demographic analytics system may offer a method of integrating respondent data collected during the online survey intercept process with audience profile data collected using a variety of techniques, and stored on different servers.

In some other embodiments, the inferential demographic analytics system may enable confirming population segmentation by city geo-location for survey domain audience profiling. The inferential demographic analytics may do so using the Haversine formula.

In another aspect, in at least one embodiment described herein, there is provided a computer-readable medium storing computer-executable instructions. The instructions cause a processor to perform a method of obtaining at least one processor to: direct respondents to one or more polling websites offering surveys using random URL intercepts, the one or more respondents being connected to a network via a client system; record survey data corresponding to inputs provided by the one or more respondents to the surveys; determine demographics data for the one or more polling websites, the demographics data comprising one or more attributes defining characteristics of the respondents; and process the survey data based on the demographics data to generate processed survey data. The method further comprises storing the survey data, the demographics data and the processed survey data in a memory coupled to the processor.

In another aspect, in at least one embodiment described herein, there is provided a website hosted on a server, the website enabling a representative online polling sample to be obtained, the website including polling information for a user to select or otherwise interact with, that polling website having a domain name that differs from the domain name of a website the user intends to reach, the polling website being reached when the user makes a typing or other address input error and inadvertently enters the polling website domain name, the audience demographic profile of the polling website(s) hosted on a separate server, thereafter reflecting the characteristics of the universe of potential survey respondents from the aforementioned websites, and the usage of such audience profile information to deduce the proper weighting of completed online intercept survey respondents, or to redirect respondents to advertising websites, panel websites, or to predict and accumulate greater characteristics and attitudes of the exposed audience of users of the survey domains over time.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

Several embodiments of the present invention will now be described in detail with reference to the drawings, in which:

FIG. 1 is a block diagram of a system for browsing Web pages according to an example embodiment.

FIG. 2A is an RDIT system according to an example embodiment.

FIG. 2B is an RDIT system according to another example embodiment.

FIG. 3 is an inferential demographic analytics system according to an example embodiment.

FIG. 4 is an inferential demographics analysis method according to an example embodiment.

The drawings are provided for the purposes of illustrating various aspects and features of the example embodiments described herein. For simplicity and clarity of illustration, elements shown in the FIGS. have not necessarily been drawn to scale. Further, where considered appropriate, reference numerals may be repeated among the FIGS. to indicate corresponding or analogous elements.

### DETAILED DESCRIPTION

Various apparatuses or processes will be described below to provide an example of at least one embodiment of the claimed subject matter. No embodiment described below limits any claimed subject matter and any claimed subject matter may cover processes, apparatuses, devices or systems that differ from those described below. The claimed subject matter is not limited to apparatuses, devices, systems or processes having all of the features of any one apparatus, device, system or process described below or to features common to multiple or all of the apparatuses, devices, systems or processes described below. It is possible that an apparatus, device, system or process described below is not an embodiment of any claimed subject matter. Any subject matter that is disclosed in an apparatus, device, system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It should also be noted that the terms “coupled” or “coupling” as used herein can have several different meanings depending in the context in which the term is used. For example, the term coupling can have a mechanical or electrical connotation. For example, as used herein, the terms “coupled” or “coupling” can indicate that two elements or devices can be directly connected to one another or connected to one another through one or more intermediate elements or devices via an electrical element, electrical signal or a mechanical element such as but not limited to, a wire or a cable, for example, depending on the particular context.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

Furthermore, the recitation of any numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

It should be noted that the term “module” as used herein can include any functional block that is implemented in hardware or software, or both, and that performs one or more functions such as the processing of an input signal to produce an output signal. As used herein, a “module” can contain “sub-modules” that themselves are modules.

The various embodiments of the devices, systems and methods described herein may be implemented using a combination of hardware and software. These embodiments may be implemented in part using computer programs executing on programmable devices, each programmable device including at least one processor, an operating system, one or more data stores (including volatile memory or non-volatile memory or other data storage elements or a combination thereof), at least one communication interface and any other associated hardware and software that is necessary to implement the functionality of at least one of the embodiments described herein. For example, and without limitation, the computing device may be a server, a network appliance, an embedded device, a computer expansion module, a personal computer, a laptop, a personal data assistant, a cellular telephone, a smart-phone device, a tablet computer, a wireless device or any other computing device capable of being configured to carry out the methods described herein. The particular embodiment depends on the application of the computing device.

In some embodiments, the communication interface may be a network communication interface, a USB connection or another suitable connection as is known by those skilled in the art. In other embodiments, the communication interface may be a software communication interface, such as those for inter-process communication (IPC). In still other embodiments, there may be a combination of communication interfaces implemented as hardware, software, and a combination thereof.

In at least some of the embodiments described herein, program code may be applied to input data to perform at least some of the functions described herein and to generate output information. The output information may be applied to one or more output devices, for display or for further processing.

At least some of the embodiments described herein that use programs may be implemented in a high level procedural or object oriented programming and/or scripting language or both. Accordingly, the program code may be written in C, Java, SQL or any other suitable programming language and may comprise modules or classes, as is known to those skilled in object oriented programming. However, other programs may be implemented in assembly, machine language or firmware as needed. In either case, the language may be a compiled or interpreted language.

The computer programs may be stored on a storage media (e.g. a computer readable medium such as, but not limited to, ROM, magnetic disk, optical disc) or a device that is readable by a general or special purpose computing device. The program code, when read by the computing device, configures the computing device to operate in a new, specific and predefined manner in order to perform at least one of the methods described herein.

Furthermore, some of the programs associated with the system, processes and methods of the embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments the medium may be transitory in nature such as, but not limited to, wire-line transmissions, satellite transmissions, Internet transmissions (e.g. downloads), media, digital and analog signals, and the like. The computer useable instructions may also be in various formats, including compiled and non-compiled code.

The various embodiments disclosed herein generally relate to improved techniques of re-weighting, or otherwise processing, survey results to reflect the character attribute of the population of the expected results. The various embodiments disclosed herein further include obtaining aggregate data on individuals exposed to online surveys, specifically random online intercept surveys.

Random online intercept surveys may be obtained by hosting online surveys on domains, such as, for example, new or existing top-level domain (TLD), country-code top-level domain (ccTLD), generic top-level domain (gTLD), or internationalized domain name (IDN), upon which a user may land unintentionally. Unintentional landing on a survey site may occur through manual typing into the URL (uniform resource locator) bar (also known as address bar or direct navigation bar) and can result from a typographical error on non-trademarked URLs; human data input errors on hitherto commercial or active domains that are now vacant or ‘parked’ with an advertising, leasing or sales site or a ‘domain parking crew’; or at a private, or country-level registrar that buys, sells, or leases URLs to the public. This polling method is commonly referred to as “random domain intercept technology” (RDIT) [2].

Random online intercept surveys provide the advantage of minimizing, and even eliminating, coverage bias of those targeted for polling. Coverage bias is minimized or eliminated when every potential respondent has an equal probability of being surveyed. Substantial coverage bias may be introduced when other types of surveying, such as print survey or telephone survey, is used. For example, in the context of telephone surveying, coverage bias is introduced since people with cellular phones are more inaccessible to the surveyor that are other potential respondents; people who work outside the home are less accessible than are other potential respondents who stay at home during the work day; furthermore, the rising number of individuals who block out telemarketing companies from reaching them by telephone are also excluded as potential respondents. However, with the use of RDIT, the online coverage bias is significantly reduced. There is no reason to believe that the people who fail to randomly fall into the potential survey population (i.e. who do not make the typographical error) have distinct characteristics from the people who do, thus increasing the validity of the results.

To further increase the validity of the survey results, various embodiments described herein relate to systems and methods of performing inferential demographic analysis on potential survey respondents when using online intercept polls or RDIT. An advantage of performing inferential demographic analysis on the survey respondents is to gather a contextual knowledge of the characteristics of the people exposed to the survey questions. This knowledge, in turn, provides new insight into the extent to which the final survey respondents are sufficiently representing certain groups of value to the researcher, such as college-educated respondents, women, people with specific Operating Systems, people responding from desktops vs. mobile phones, or people with or without children etc. For example, this information may allow researchers to assess the proportion of college-age online intercept survey respondents who completed the study to determine if, and to what degree, there was concordance or discordance between the exposed population of online survey exposures and the sub-population who answered the full survey from among the group randomly exposed to the survey domains where polls are hosted.

The various embodiments disclosed herein further disclose systems and methods for mathematically adjusting the survey results to match the attributes of the universe of people exposed to the survey(s). Adjustment weighting may involve capturing the variables that need to be weighted (e.g., age, religion) in a survey and researching the expected results for the weighted variables from the audience profile repository and then applying the data repository to the online intercept survey results in a programming software, such as, for example, R, using a raking algorithm.

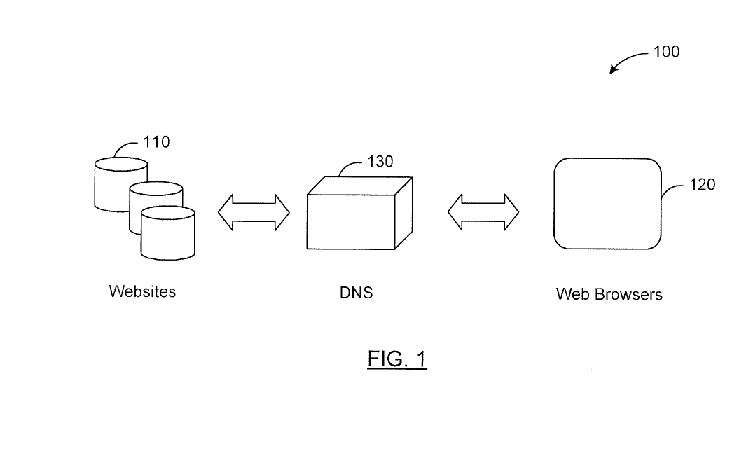

Reference is first made to FIG. 1, illustrating a system 100 for browsing Web pages according to an example embodiment. As illustrated, FIG. 1 shows the contingent survey domain intercept arrangement, in which websites 110 are each labeled with a unique domain name, such as goslam.com or goslam.bar, etc. Users enter the required domain name into their Web browser 120 and the domain name server (DNS) 130 routes the request to the appropriate website, which then returns to the requesting Web browser 120 data needed to reconstruct a Web page.

In various embodiments, the user accesses the Web browser 120 using client system, which may be any networked computing device including a processor and memory, such as a personal computer, workstation, server, portable computer, mobile phone, personal digital assistant, laptop, smart phone, WAP phone, or a combination of these. Client system typically includes one or more input devices, such as a keyboard, mouse, camera, touch screen and a microphone, and also includes one or more output devices such as a display screen and a speaker. Client system typically has a network interface for connecting to network in order to communicate with other components.

Network may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

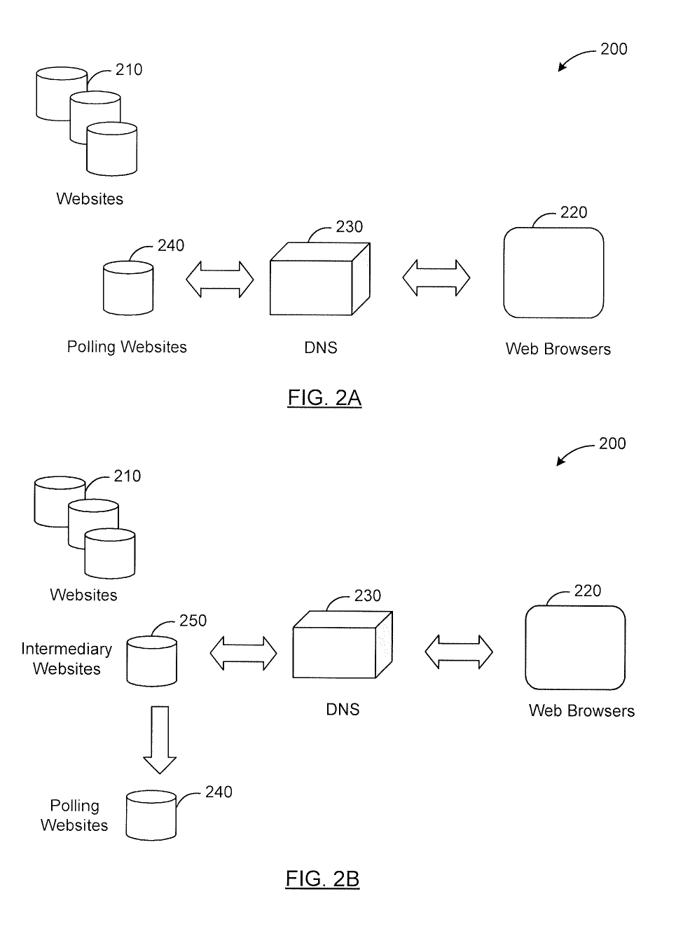

Reference is next made to FIG. 2A and FIG. 2B illustrating an RDIT system 200 according to a first and a second example embodiment respectively. As illustrated in FIG. 2A, RDIT system 200 comprises a website 210, a Web browser 220, domain name server(s) 230 and polling website(s) 240. With an implementation of the URL intercept process, the polling website 240 has a domain name that is similar to the domain name of a website 210 that the user intends to reach. However, the user inadvertently reaches the polling website 240 when the user incorrectly types in the domain name into the Web browser 220 URL line of the website 210 he intends to reach. Instead, the user types in the domain name associated with the polling website 240. For example, the user might want to reach “mychildschool.com” but he types in “mychldschool.com” instead. An individual or company may have registered the latter domain name and that domain name resolves via DNS 230 to a polling website 240 and not another website 210.

FIG. 2C illustrates a variant of FIG. 2B, in which an intermediary website 250 has a domain name similar to that of a conventional website 210. When the user inadvertently enters the intermediary website 250 domain name into the URL address bar of his Web browser 220, the DNS 230 resolves the query to intermediary website 250. The intermediary website 250 can be a landing page website, or a news website, or some other kind of website with content that the user may find interesting. The objective of the intermediary website 250 is to engage the user by providing relevant content. The intermediary website 250 might include a hyperlink to the full polling website 240 as explained above. In another implementation, some (or possibly all) unused domain names within one or more of the ccTLDs, gTLDs, IDNs or TLDs automatically redirect the user to the intermediary website (if a FIG. 2B type scheme is used) or directly to a polling website (if a FIG. 2C type scheme is used) because a wildcard redirect has been used in the DNS 230 for that ccTLD or TLD.

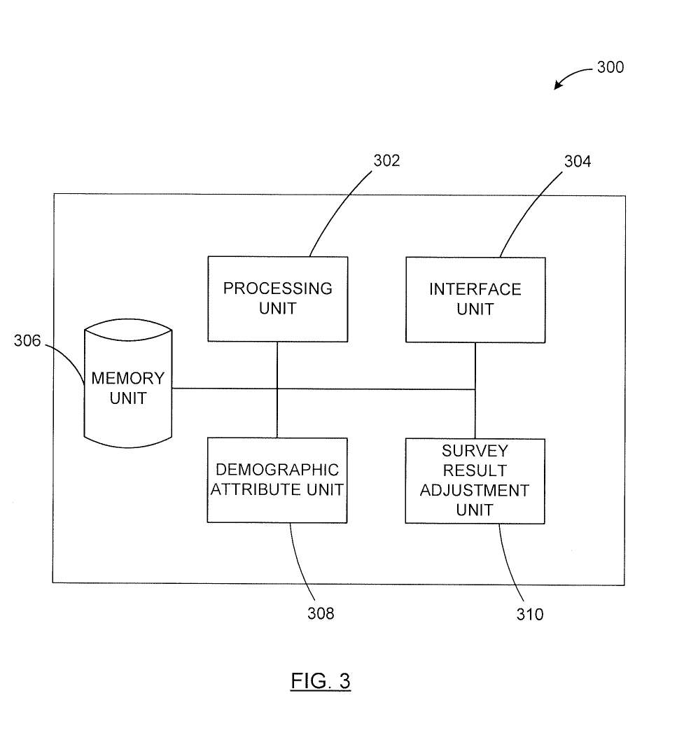

Reference is next made to FIG. 3 illustrating inferential demographic analytics system 300 according to an example embodiment. Inferential demographic system 300 comprises a processing unit 302, an interface unit 304, a memory unit 306, a demographics attribute unit 308 and a survey result adjustment unit 310.

The processing unit 302 controls the operation of the inferential demographic analytics system 300. The processing unit 302 can be any suitable processor, controller or digital signal processor that can provide sufficient processing power processor depending on the configuration, purposes and requirements of the inferential demographic analytics system 300. For example, the processing unit 302 may be a high performance general processor. In alternative embodiments, the processing unit 302 can include more than one processor with each processor being configured to perform different dedicated tasks. In alternative embodiments, it may be possible to use specialized hardware to provide some of the functions provided by the processing unit 302.

The interface unit 304 can be any interface that allows the inferential demographic analytics system 300 to communicate with other devices or computers. In various cases, the interface unit 304 includes network or network components capable of carrying data including the Internet, Ethernet, plain old telephone service (POTS) line, Firewire modem, public switch telephone network (PSTN), integrated services digital network (ISDN), digital subscriber line (DSL), coaxial cable, fiber optics, satellite, mobile, wireless (e.g. Wi-Fi, WiMAX, radio communicating utilizing CDMA, GSM, GPRS or Bluetooth protocol according to standards such as IEEE 802.11a, 802.11b, 802.11g, or 802.11n), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.), and others, including any combination of these. In some other cases, the interface unit 304 includes at least one of a serial port, a parallel port or a USB port that provides USB connectivity.

The memory unit 306 can include RAM, ROM, one or more hard drives, one or more flash drives or some other suitable data storage elements such as disk drives, etc. The memory unit 306 is used to store an operating system and programs, where the operating system provides various basic operational processes for the inferential demographic analytics system 300 and the programs include various user programs so that a user can interact with the inferential demographic analytics system 300 to perform various functions such as, but not limited to, viewing and manipulating data as well as sending messages as the case may be. In various embodiments, the memory unit 306 stores survey results of the surveys carried out using RDIT.

The demographics attribute unit 308 is a storage and processing module configured to manage attribute classification taxonomies for survey respondents relevant to survey domains. Examples of attribute classification taxonomies may include percentage of male or female users, percentage of users with or without children etc.

The demographics attribute unit 308 may be configured to obtain demographic information for the survey respondents based on a variety of techniques, such as, for example, Web analytics of historical domain usage, URL spelling similarity statistical analysis, and self-reported URL user profile information that enables the users of the intercepted survey domains to opt in, prior to the survey, to provide demographic data including, but not limited to, age, gender, education level, income, Web browsing location, and whether or not the Web user does or does not have children etc.

For example, in some embodiments, the inferential demographic analytics system 300 recruits potential online survey recipients to a recruited online panel and prior to any survey exposure, have the potential respondents, who have joined the panel in order to receive money, sweep stakes or other incentives in exchange for participating in future polls, input demographic information about themselves. In another example, the inferential demographic analytics system 300 has access to demographic data on online potential survey respondents because the potential respondents are on a membership list to which they have provided data such as their e-mail address or mobile telephone number, and the latter information is thereafter used for survey engagement purposes for the prospective survey respondents on the list.

There may be some disadvantages associated with relying on respondents themselves for gathering demographic information. For example, it may be extremely burdensome and expensive to recruit online incentivized survey respondents using the aforementioned methods. Itinerant panel members have been identified as 2.55 times heavier Internet users than average users, are usually on multiple panels, and actively seek to be members of panels in exchange for rewards [3]. Furthermore, since the members of the online panel rarely, if ever, remain on the panel for more than six months, it is challenging to compare the sub-population of actual survey respondents from a panel to a stable universe of panel members with distinct, self-identified attributes, including their Web usage frequency.

In various other embodiments, the inferential demographic analytics system 300 collects audience profile or demographics data using a variety of other techniques. For example, in some cases, the audience profile data are gathered through domain demographic database tools, such as Alexa™.com, Quantcast™, etc. Such domain demographic database tools may be downloadable browser-based software plug-in tools that enable those who download the plug-in to input data about their browsing habits, educational, ethnic, gender, political affiliation and household attributes. Some demographic database systems like Alexa™ use browser plug-ins whereas others embed Web traffic monitors in ISPs.

In some other cases, the audience profile data are gathered through Web analytics using IP cookies that gather IP-specific information from users of these domains, including geographic location, the relative number and proportion of unique visitors per day and per month registered from different country-specific IP addresses; the relative number and proportion of unique visitors per day and per month registered from different country-specific operating systems (such as Windows™, Macintosh™ Linux™, Blackberry™, Symbian™, Java™); and the relative number and proportion of unique visitors per day and per month registered from different country-specific browsers (such as Google Chrome™, Microsoft Internet Explorer™, Firefox™, Mozilla™ Safari™, Android PDA™, Opera™, or Samsung PDA™). Unique visitors are visitors whom are classified as “unique” by a set of criteria, usually based on IP address or cookie. In various embodiments, each “unique” visitor is only counted once, even if they visit the same site multiple times. IP cookie, also referred to as an HTTP cookie, Web cookie, or browser cookie, is a small piece of data sent from a website and stored in a user's web browser while the user is browsing that website. When the user loads the website, the browser sends the cookie back to the server to notify the website of the user's activity.

In some further cases, the gathering of audience profile data are based on reasoning by analogy. In this embodiment, if the survey domains are nearly identical in wording except for an objectively clear single-letter typographical error on a non-trademarked domain whose grammar and syntax in the proper spelling formulation demonstrably signifies the clear intended content of the URL, the audience profile data of one such misspelled domain are inferred to be statistically identical to the other. An example where reasoning by analogy technique is used to gather audience profile data includes URLs “parentingadvice.com” and “parentingadvise.com”. This approach is different from taxonomic categorization of topic categories based on algorithmic keywords in the website content with a semantic reasoner classification system, used by companies such as SimilarWeb™ and Zvelo™. Further, this method auto-curates taxonomies through the syntactical parsing of similar URL spellings such that the computer learns these clusters and statistically measures URL similarity without the heavy human intervention required in semantic reasoner classification systems.

Other techniques of gather demographics or audience profile data may be used by the inferential demographic analytics system 300.

The demographics attribute unit 308 is further configured to classify and sort demographic data obtained using various techniques mentioned above. In some embodiments, the demographics data may be sorted based on the taxonomy classifications, such as, college-educated respondents, women, people with specific operating systems, people responding from desktops vs. mobile phones, or people with or without children etc.

In some other embodiments, the demographics data are classified and stored based on survey domains where online surveys are hosted. In some further embodiments, when the demographics data are classified and stored based on survey domains, the demographics data corresponding to the various survey domains can be accumulated on a daily basis in a full repository. The accumulation of domain-specific demographics data may occur by the processing unit 302 and the storage of the full repository may occur at the memory unit 306.

In some further embodiments, the demographics attribute unit 308 may be configured to sort and store the demographics data based on geo-location of the respondents. In some cases, the geo-location of the respondents using IP address may be carried out using third-party software, such as MaxMind™, geoPlugin™ IP2Location™, Quova™, Digital Envoy™, NetGeo™, Cyscape™, CountryHawk™, Digital Element™, and IPligence™, combined with longitudinal and latitudinal algorithms. In some other cases, the population segmentation by city geo-location for survey domain audience profiling may be confirmed or carried out by the Haversine formula. This confirms the distance between any city center and an observation (IP) and thereby calculates, from the IP latitudes and longitudes, the city location. Each observation (IP address) is then classified in the audience profile repository as a city center by determining if the distance to the target city is within the approximate radius of that metropolitan area. Repeating the classification for each IP observation for every target city center may enable real-time processing within the audience profile server. This classification technique may cluster observations into more refined city centers. For example, a 50 km radius from the city center captures two times the respondent observations in Toronto and five times in New York. There are some cities such as Brussels where the radius must be reduced to exclude adjacent city centers such as Antwerp. In some further cases, for added confirmation, the demographics attribute unit 308 applies the Equirectangular approximation, which is sufficient when only requiring relative thresholds for city center classification. In some cases where full table scans are too computationally burdensome in a specific situation (especially where many cities in many countries require classification), the demographics attribute unit 308 applies a ‘decision tree’ approach that is partitioned by country and region to reduce the number of nodes (possible city centers) traversed.

The survey result adjustment unit 310 is a storage and processing module configured to process, such as re-weight or adjust, survey results based on demographics attributes related to the survey respondents. Survey result adjustment unit 310 is configured to compare survey responses captured through the intercept process to the taxonomies stored at the demographics attribute unit 308.

Survey result adjustment unit 310 is further configured to carry out a mathematical interpretation of the demographic profile of the portfolio of the habitual users of the selected random survey domains. For example, in one embodiment, the survey result adjustment unit 310 can map the percentage of college-age educated respondents (or some other domain profile attribute, such as religion, gender, online gaming frequency or household income) who ultimately completed a survey to determine if there was concordance or discordance between the exposed target population of interest generated via survey domain attributes and the attributes of the sub-population of ‘completes’ (i.e., those who answered the full survey from within this larger population group).

The survey result adjustment unit 310 is further configured to enable mathematical re-weighting techniques of the population parameter of the final survey pool of respondents by examining the characteristics of the hundreds, or thousands, of random websites (including TLDs, ccTLDs, gTLDs, and IDNs) served up to potential survey respondents via redirects from the DNS, or those domains mistakenly stumbled upon the Web user that may also host URL intercept surveys.

The survey result adjustment unit 310 may be further configured to extrapolate from the inferred attributes on the audience profile of those exposed to the survey to calculate the margin of error, or representativeness, of the completed survey results where the same attribute questions are asked of each of the potential respondents. In various embodiments, the survey result adjustment unit 310 extrapolates by re-weighting the variables that need to be re-weighted (e.g. age, religion etc.) in a survey, researching the expected results for the weighted variables from the audience profile repository, and then applying the data repository to the intercept survey results in the programming software, R, using a raking algorithm. R is a software programming language and software environment for statistical computing and graphics (available at: http://www.r-project.org), and raking (also called raking ratio estimation) is a post-stratification procedure for adjusting the sample weights in a survey so that the adjusted weights add up to known population totals for the post-stratified classifications when only the marginal population totals are known.

The survey result adjustment unit 310 may be further configured to sort or segregate members of the respondent sample by country or by territory location using IP addresses for the purposes of comparing the attributes of the completed survey results to the audience profile of the potential respondents exposed to the survey websites.

In some embodiments, the survey result adjustment unit 310 may be further configured to redirect respondents of completed surveys to advertising websites, where the audience profile of the survey website or websites are similar to the audience profile of the website or websites upon which advertisements or informational campaigns are hosted.

In some further embodiments, the survey result adjustment unit 310 may be configured to redirect respondents of completed surveys to online panel websites that offer recruited opt-in services, where the audience profile of the survey website or websites are similar to the audience profile of the online panel company, for instance, where the online panel company specializes in recruiting panelists from a specific age group, geography, gender or other major audience characteristic inferred from the survey website(s).

In various embodiments, the survey result adjustment unit 310 may be configured to use Bayesian modeling or related statistical techniques to further assess the characteristics of the universe of successive groups of people who answer different online intercept surveys over time, through the process of analyzing how the survey respondents to multiple surveys hosted on the same websites answer different questions, and, in the course of this process, supplement the audience website profile characteristics via the answers to the successive survey questions and responses. Bayesian modeling enables the researcher, when using this method, to successively build an ever-richer meta-analytic profile of the survey domain audience profile, thereby accumulating the survey-specific probabilities (e.g., relating to respondent attitudes about online purchasing behavior of shoes) from individual answers, over time, to surveys hosted on the portfolio of domains possessing the prior audience demographics. Bayesian statistical modeling methods in meta-analysis and evidence synthesis are capable of building up the audience profile attributes of the survey domains, since the modeling approach offers the ability to extend the model to accommodate more complex, but frequently occurring, scenarios of a diverse array of survey designs that yield different probabilities about events occurring, or about opinions that are held, by those successive respondents who answer the different surveys [4].

In various embodiments, the inferential demographic analytics system 300 described herein is scalable to include hundreds or thousands of online intercept domains and hundreds of thousands of databases upon which domain profile data may be separately stored. In various cases, the inferential demographic analytics system 300 allows for the examination of the completed survey results and comparison of attributes, such as age, gender, religion or ethnicity distribution etc. of potential survey respondents to actual respondents in order to determine the degree of survey domain audience profile representativeness which the latter reveals. In various cases, the inferential demographic analytics system 300 further allows for re-weighing of the final survey data to be more representative of the exposed potential respondents.

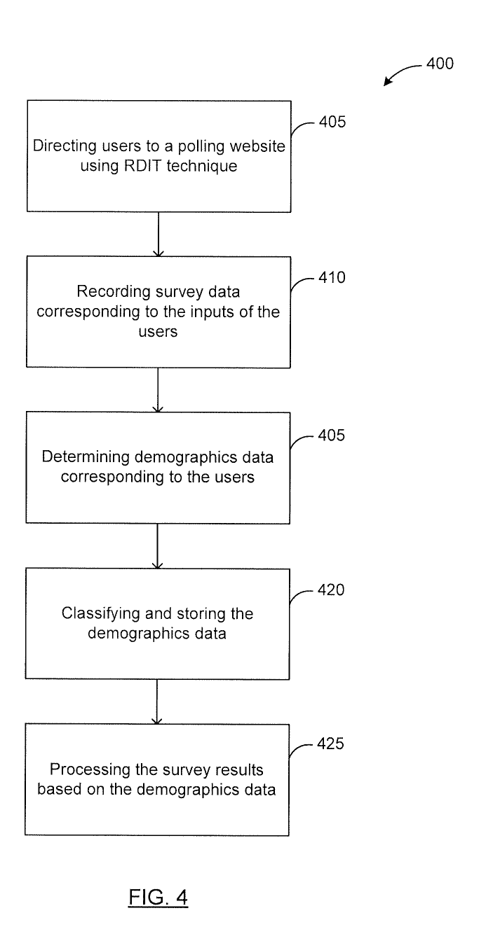

Reference is next made to FIG. 4, illustrating an inferential demographics analysis method 400 in accordance with the teachings herein. The method 400 is carried out by the various modules of an inferential demographics analytics system, such as inferential demographics analytics system 400.

At 405, one or more users are directed to one or more polling websites using RDIT technique. In various embodiments, users include potential respondents of the online surveys.

At 410, survey data corresponding to the input of the users to the polling websites is recorded. The survey data may be recorded in the memory unit 306 of the inferential demographics analytics system 400.

At 415, demographics or profile data corresponding to the user is determined. As described herein, the demographics data may be obtained using some or all of the following techniques of Web analytics on IP histories on every domain, software plug-in self-reported user data affiliated with each domain, and reasoning by analogy to infer the demographic profile of domains with near-identical URLs for non-trademarked URLs with one-letter differences in ASCII or non-ASCII script. ASCII is a text code for representing English characters as numbers, with each letter assigned a number from 0 to 127. In some other embodiments, other techniques of obtaining demographics data may be used.

At 420, the obtained demographics data are classified and stored based on one or more criteria. Such criteria may include taxonomy classifications, geo-location of the respondents, survey domains where online surveys are hosted etc.

At 425, the stored demographics data are used to process the survey results according to the teachings herein. For example, the processing of survey results may include re-weighting survey results by assigning taxonomic attributes proportionately to the survey responses according to the proportionate amount of survey respondents who answered from different websites, where each site has different audience demographic characteristics as registered in the said database.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. The scope of the claims should not be limited by the preferred embodiments and examples, but should be given the broadest interpretation consistent with the description as a whole.

### REFERENCES

[1] Fienberg, S E. When did Bayesian Inference become “Bayesian”? 2006 Bayesian Analysis, 1 (1), 1-40. Available online: http://ba.stat.cmu.edu/journal/2006/vol01/issue01/fienberg.pdf. Retrieved Sep. 4, 2014.
[2] Gian Fulgoni. Numbers, please: Uses and Misuses of Online-Survey Panels in Digital Research. 2014 Journal of Advertising Research. Vol. 54, No. 2.
[3] Tim Macer (Oct. 14, 2013). Disruptive Change. Research World: World Association for Market, Social and Opinion Research. Available online: http://rwconnect.esomar.org/disruptive-change/.Retrieved Sep. 4, 2014.
[4] Sutton A J, Abrams K R. Bayesian methods in meta-analysis and evidence synthesis. Statistical Methods in Medical Research 2001 Aug. 10(4): 277-303.

1. A method of operating an inferential demographic analytics system, the method comprises:
obtaining at least one processor to:
direct respondents to one or more polling websites offering surveys using random URL intercepts, the one or more respondents being connected to a network via a client system;
record survey data corresponding to inputs provided by the one or more respondents to the surveys;
determine demographics data for the one or more polling websites, the demographics data comprising one or more attributes defining characteristics of the respondents; and
process the survey data based on the demographics data to generate processed survey data; and
storing the survey data, the demographics data and the processed survey data in a memory coupled to the at least one processor.

2. The method of claim 1, wherein the one or more attributes comprised in the demographics data are selected from the group consisting of age, gender, education level, ethnicity, income, web browsing location, whether or not the respondents have children, browsing habits, political affiliation and voter preference.

3. The method of claim 1, wherein the demographics data are determined by downloading a browser-based software plug-in tool to the client system.

4. The method of claim 1, wherein the demographics data are determined via Web analytics using IP cookies for gathering IP-specific information for the respondents.

5. The method of claim 4, wherein the IP-specific information is selected from the group consisting of geographic location, the relative number and proportion of unique visitors per day and per month registered from different country-specific IP addresses, the relative number and proportion of unique visitors per day and per month registered from different country-specific operating systems, and the relative number and proportion of unique visitors per day and per month registered from different country-specific browsers.

6. The method of claim 1, wherein the demographics data are determined by applying attributes from domain demographics databases on the polling websites deploying the surveys.

7. The method of claim 6, wherein the domain demographics database comprises a website.

8. The method of claim 1, wherein the demographics data for a polling website are classified as statistically identical to the demographics data for a non-trademarked domain name, wherein the polling website and the domain name are identical in spelling with an exception of a single-letter typographical error and wherein the grammar and syntax in the proper spelling formulation of the domain name demonstrably signifies the intended content of the website corresponding to the domain name.

9. The method of claim 1, further comprising sorting the demographics data based on pre-determined criteria.

10. The method of claim 9, wherein sorting the demographics data based on pre-determined criteria comprises sorting the demographics data based on location by using IP address of each client system corresponding to each respondent.

11. The method of claim 9, wherein sorting the demographics data based on pre-determined criteria comprises sorting the demographics data based on the one or more attributes.

12. The method of claim 9, wherein sorting the demographics data based on pre-determined criteria comprises sorting the demographics data based on the polling websites.

13. The method of claim 1, further comprising extrapolating information from the survey data based on the demographics data.

14. The method of claim 13, wherein the extrapolated information comprises predictions regarding respondent opinions on certain issues.

15. The method of claim 1, further comprising generating indicia of Web representativeness of respondents based on the demographics data.

16. The method of claim 15, wherein the Web representativeness is based on geography.

17. The method of claim 15, further comprising re-weighting survey data based on the indicia of Web representativeness to generate processed survey data.

18. The method of claim 1, further comprising providing online advertisements to the respondents based on dominant attribute in the demographics data of the polling website.

19. An inferential demographic analytics system comprising:
a memory unit; and
a processing unit coupled to the memory unit, the processing unit being configured to:
direct respondents to one or more polling websites offering surveys using random URL intercepts, the one or more respondents being connected to a network via a client system;
record survey data corresponding to inputs provided by the one or more respondents to the surveys;
determine demographics data for the one or more polling websites, the demographics data comprising one or more attributes defining characteristics of the respondents;
process the survey data based on the demographics data to generate processed survey data; and
store the survey data, the demographics data and the processed survey data in the memory unit.

20. A computer-readable medium storing computer-executable instructions, the instructions for causing a processor to perform a method of operating an inferential demographic analytics system, the method comprising:
obtaining at least one processor to:
direct respondents to one or more polling websites offering surveys using random URL intercepts, the one or more respondents being connected to a network via a client system;
record survey data corresponding to inputs provided by the one or more respondents to the surveys;
determine demographics data for the one or more polling websites, the demographics data comprising one or more attributes defining characteristics of the respondents; and
process the survey data based on the demographics data to generate processed survey data; and
storing the survey data, the demographics data and the processed survey data in a memory coupled to the at least one processor.
